(19) United States
(12) Patent Application Publication
(10) Pub. No.: US 2023/0295543 A1
(43) Pub. Date: Sep. 21, 2023

(54) LAUTER COMPONENT OF A BREWING SYSTEM

(71) Applicant: Unique Bavarian Brewery, LLC, Castle Pines, CO (US)

(72) Inventors: Michael Anthony Lentz, Bangkok (TH); Wilhelm Trappe, Vienna (AT); Paramase Pholphanich, Nonthaburi (TH); Onnicha Boonsavapark, Pathum Thani (TH)

(21) Appl. No.: 18/186,930

(22) Filed: Mar. 20, 2023

Related U.S. Application Data
(60) Provisional application No. 63/321,479, filed on Mar. 18, 2022.

(51) Int. Cl. C12C 7/06

(52) U.S. Cl. CPC C12C 7/065; C12C 7/067

(57) ABSTRACT

A component of a brewing system is provided, which comprises: a tank; a whirl arm disposed within the tank; an inlet pipe coupled with the whirl arm; and an outlet pipe coupled with a fluid coupling system; wherein the tank is configured for filtering a mash to form a wort. A brewing system is provided, which comprises: a first and a second tank, and a fluid coupling system, the second tank comprising: an inner and an outer cylinder; a whirl arm within the second tank; an inlet pipe coupled with the whirl arm and the fluid coupling system; and an outlet pipe coupled with the fluid coupling system. A method is provided, which comprises: receiving mash within a second tank from a first tank; circulating mash to form wort; transferring the wort into the first tank; receiving wort within the second tank from the first tank; and chilling the wort.

### CROSS-REFERENCE TO RELATED APPLICATION

This application claims priority to U.S. Provisional Application No. 63/321,479, titled “Brewing System,” filed on Mar. 18, 2022, the entire disclosure of which is hereby incorporated by reference in its entirety.

### BACKGROUND

Brewing beverages, for example brewing beer, is typically a laborious process that requires several individually conducted steps and large equipment for conducting these steps. The brewing process may be composed of the steps of mashing a milled grain to create a mash, boiling the mash, lautering the mash to form wort and spent grains, clarifying the wort, and fermenting the resulting clarified wort. In typical brewing processes, the equipment required to accomplish these steps may be expensive and occupy a large floor space. The process may additionally require qualified brewing technicians and cleaning staff.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In examples, a component of a brewing system having an outer housing enclosing at least the component and the fluid coupling system is provided. The component comprises: a tank including an inner cylinder disposed at least partially within an outer cylinder; a whirl arm disposed within an upper portion of the tank; an inlet pipe fluidly coupled with the whirl arm; and an outlet pipe fluidly coupled with the fluid coupling system of the brew system; wherein the tank component is configured for filtering a mash to form a wort.

In another example, a brewing system is provided. The brewing system comprises: a first tank arranged adjacent to a second tank and a fluid coupling system arranged between the first tank and the second tank, the second tank comprising: an inner cylinder disposed at least partially within an outer cylinder; a whirl arm arranged within an upper portion of the first tank; an inlet pipe fluidly coupled with the whirl arm and the fluid coupling system; an outlet pipe fluidly coupled with the fluid coupling system; and wherein the first tank has a volumetric capacity of approximately 240 liters.

In a further example, a method of brewing a beverage using a brewing system is provided. The method comprises: receiving mash within the second tank from the first tank; circulating mash through the second tank to form wort; transferring the wort from the second tank into the first tank; removing mash cake formed within a grid basket assembly of the second tank; receiving boiled wort within the second tank from the first tank; and chilling the wort within the second tank.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF FIGURES

Non-limiting and non-exhaustive examples are described with reference to the following Figures.

FIG. 1 illustrates a top perspective view of the brewing system which is defined by a generally rounded rectangular shape.

FIG. 2 illustrates a top perspective view of a portion of the brewing system, and more particularly, various of the internal components of the brewing system.

FIG. 3 illustrates a top view of the brewing system without the covers arranged over the first and second tanks.

FIG. 4 illustrates a cross-sectional view of a portion of a brewing system.

FIG. 5 illustrates an exploded view of the inner cylinder and the outer cylinder.

FIG. 6 illustrates an enlarged view of the heating coil.

FIG. 7A illustrates a top view of the inner cylinder base.

FIG. 7B illustrate a cross-sectional view of the inner cylinder base.

FIG. 8 illustrates an enlarged side perspective view of an inlet pipe.

FIG. 9 illustrates an exploded view the whirl arm.

FIG. 10 illustrates a cross sectional view of a coupling between an inlet pipe and a whirl arm facilitated by a cover and a T-pipe coupler.

FIG. 11 illustrates an exemplary grid basket assembly.

FIG. 12A illustrates an enlarged view of a mesh plate.

FIG. 12B illustrates an enlarged view of a grid basket.

FIG. 13 illustrates a lauter door assembly for a grid basket assembly.

FIG. 14 illustrates an exploded view of a trolley assembly.

FIG. 15A illustrated a top schematic view of the trolley plate cover 180 coupled with the folding plate in a folded configuration.

FIG. 15B illustrated a top schematic view of the trolley plate cover coupled with the folding plate in an extended configuration.

FIG. 16 illustrates a flow of mash through a brewing system.

FIG. 17A illustrates a side perspective view of an outer housing of a brewing system, and more particularly, a portion of the outer housing having a second tank.

FIG. 17B illustrates a perspective view of a window panel of a second tank cover plate actuated downwards along with a lauter door assembly such that a grid basket assembly is exposed.

FIG. 17C illustrates a brewing system with a grid basket assembly exposed to a user and a trolley assembly position directly adjacent an outer housing of a second tank.

FIG. 17D illustrates a grid basket supported by a trolley assembly.

FIG. 17E illustrates a brewing system after removal of a grid basket assembly.

FIG. 18 illustrates an exemplary method for using a second tank during the process of brewing a liquid.

### DETAILED DESCRIPTION

Various aspects of the disclosure are described more fully below with reference to the accompanying drawings, which forms a part hereof, and which show specific example aspects. However, different aspects of the disclosure may be implemented in many different ways should not be construed as limited to the aspects set forth herein. The following detailed description is, therefore, not to be taken in a limiting sense.

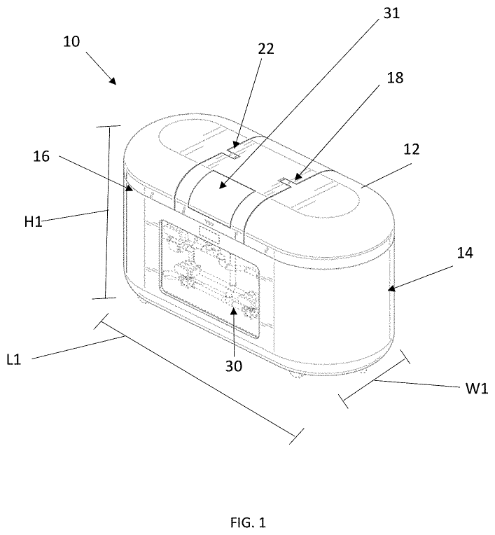

The present embodiment presents a brewing system 10 for use in brewing liquid, for example, for brewing beer. While described throughout as being used for brewing beer, various other liquids may be produced within the brewing system 10. FIG. 1 illustrates a top perspective view of the brewing system 10 which is defined by a generally rounded rectangular shape. More particularly, the brewing system 10 comprises an outer housing 12 that comprises a generally rectangular portion and at least two rounded portions arranged on either end of the rectangular portion. As will be described further herein, the rounded portions may be configured for housing a plurality of tanks within the outer housing 12. As illustrated, the brewing system 10 has a length L1 of approximately 230 cm and a height of approximately 155 cm. The height may be defined as a total height of the brewing system 10 from the bottommost surface to a topmost surface. Additionally, the brewing system 10 may have a width of approximately 100 cm. In embodiments, the length L1 may be approximately 7 feet, the width W1 may be approximately 2 feet, and the height H1 may be approximately 5 feet. As a result, the brewing system 10 may cover a ground or floor area of approximately 2.5 m². However, the values provided herein for the above described dimensions of the brewing system 10 are provided as examples and other values may be incorporated. For example, the length L1, the width W1 and the height H1 may all vary depending on the size desires and/or constraints of the brewing system 10.

Further, as will be described further herein, the outer housing 12 may hold a volume of liquid of approximately 30 L to 200 L. In other words, up to 200 L of beer may be brewed at a time within the brewing system 10. However, various other values of liquid may be supported within the brewing system 10 and the above values are provided merely for example. Additionally, the brewing system 10 may be composed of various materials, such as stainless steel and/or titanium. However, various other materials may be incorporated. The weight of the brewing system 10 may be approximately 600 kg to 840 kg. In further embodiments, depending on the materials used, the weight of the brewing system 10 may be less than or greater than the provided example range.

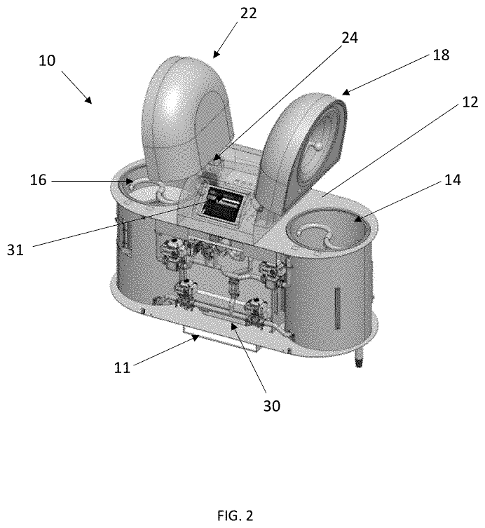

FIG. 2 illustrates a top perspective view of a portion of the brewing system 10, and more particularly, various of the internal components of the brewing system 10. As illustrated, the brewing system 10 includes a first tank 14 positioned distal to a second tank 16 within an interior region of the outer housing 12. The first tank 14 and the second tank 16 may be fluidly coupled through a fluid coupling system 30 positioned between the first tank 14 and the second tank 16. Additionally, the outer housing 12 may include an operator interface 31 arranged between the first tank 14 and the second tank 16. The operator interface 31 may be actuated by a user for selecting a recipe for brewing which may be linked with a software system of the brewing system 10 to cause automatic brewing of the selected recipe.

Further, each of the first tank 14 and the second tank 16 may have a respective cover configured for reversibly covering the first and second tanks 14, 16. More particularly, the first tank 14 has a cover 18 having a hinged connection with the outer housing 12 adjacent to the first tank 14. As illustrated best in FIGS. 1 and 2, the cover 18 is coupled with the outer housing 12 at a hinge assembly 20 such that the cover 18 may be hinged open over the first tank 14 from the configuration shown in FIG. 1 to hinged closed over first tank 14 in the configuration shown in FIG. 2. The hinge assembly 20 may be manually actuated and/or automatically actuated through the operator interface 31. With reference still to FIGS. 1 and 2, the second tank 16 also includes a cover 22 having a hinged connection with the outer housing 12 adjacent to the second tank 16. Similar to the cover 18 of the first tank 14, the cover 22 is coupled with the outer housing 12 adjacent the second tank 16 through a hinge connection, namely a hinge assembly 24. In this way, the cover 22 may be manually and/or automatically actuated from the closed configuration of FIG. 1 to the open configuration illustrated in FIG. 2. The covers 18, 22 may be selectively opened when adding ingredients into the first and second tanks 14, 16 and/or when contents of the first and second tanks 14, 16 are being boiled to allow vapor to be released from the first and second tanks 14, 16. In some embodiments, the first tank 14 may be referred to as the brew tank while the second tank 16 may be referred to as the lauter tank.

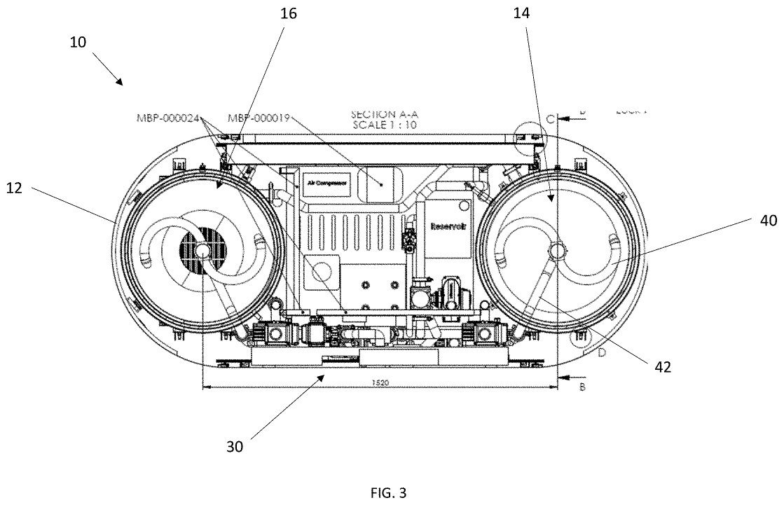

FIG. 3 illustrates a top view of the brewing system 10 without the covers 18, 22 arranged over the first and second tanks 14, 16. As illustrated, the first tank 14 and the second tank 16 are positioned distal to one another within the outer housing 12, with the fluid coupling system 30 positioned therebetween.

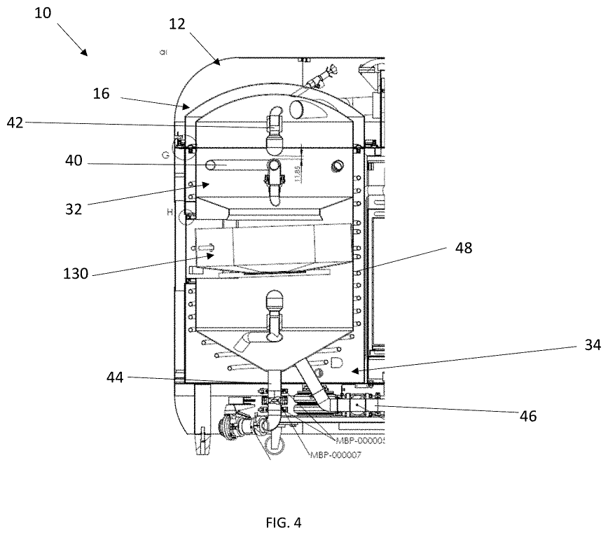

FIG. 4 illustrates a cross-sectional view of a portion of the brewing system 10, illustratively the second tank 16. With reference to FIG. 4, the second tank 16 will be described further herein. As illustrated, the second tank 16 may be composed of two separate cylinders such that the second tank 16 is defined by an inner cylinder 32 at least partially received within an outer cylinder 34. Each of the inner cylinder 32 and the outer cylinder 34 comprise a generally cylindrical configuration, however various other shapes or configurations may be incorporated. Additionally, as illustrated in the cross-sectional view of FIG. 4, the second tank 16 includes a coil 48 arranged between the inner cylinder 32 and the outer cylinder 34.

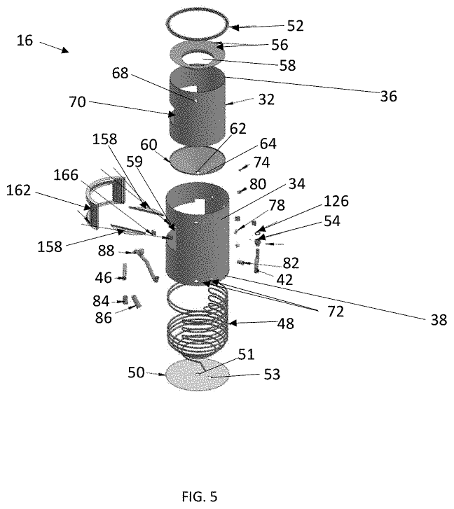

FIG. 5 illustrates an exploded view of the inner cylinder 32 and the outer cylinder 34. The inner cylinder 32 may have a volume of approximately 316 liters and may be defined by a first cylinder wall 36 having a wall thickness of approximately 2 mm. The outer cylinder 34 may have a volume of approximately 316 liters and be defined by a second cylinder wall 38 having a wall thickness of approximately 2 mm. In this way, the second tank 16 may have volume of approximately 240 L, such that the first tank 14 has a brew capacity of 200 L. Additionally, each of the inner cylinder 32 and the outer cylinder 34 may be composed of stainless steel.

Additionally, as illustrated in FIGS. 3-4, the second tank 16 additionally includes a whirl arm 40 arranged therein. The whirl arm 40 may be coupled with an inlet pipe 42 which is configured for coupling the whirl arm 40 with the fluid coupling system 30. As illustrated best in FIG. 4, the whirl arm 40 and the inlet pipe 42 are both positioned within an upper portion of the second tank 16. For example, the whirl arm 40 and the inlet pipe 42 are both arranged within the upper half of the second tank 16.

With reference to FIGS. 4-5, the brewing system 10 additionally includes an outlet pipe 44 which may fluidly couple the second tank 16 and the fluid coupling system 30 such that fluids may exit the second tank 16. The brewing system 10 includes a waste-water outlet pipe 46 which is coupled with the second tank 16 at a bottommost portion of the second tank 16 and may be used for delivering fluids from the second tank 16 to a waste-water tank 11 (FIG. 2) during the process of brewing. More particularly, during the cleansing of the second tank 16 the wastewater and remaining fluid may exit into the waste-water tank 11 (FIG. 2). It will be appreciated that, in other examples, waste-water tank 11 may be omitted, such that waste-water is alternatively, or additionally, expelled from brewing system 10 accordingly. The various pipes described herein all function to provide mechanisms for fluidly coupling the second tank 16 with the fluid coupling system 30 and/or various other components of the system to ensure fluids may be delivered to and may exit the second tank 16 during the brewing process.

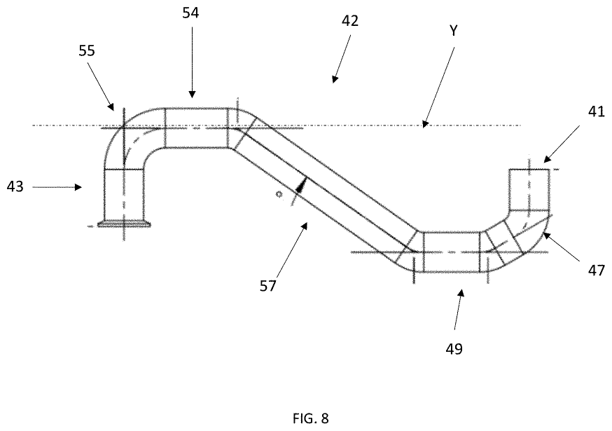

With reference now to the exploded view of FIG. 5, the components of the second tank 16 will be described further herein. As illustrated, the second tank 16 includes the inner cylinder 32 and the outer cylinder 34, the inner cylinder 32 configured to be at least partially received within the outer cylinder 34. Further, the second tank 16 may include the coil 48 as illustrated which may extending between the inner cylinder 32 and the outer cylinder 34. Further, arranged vertically above the inner cylinder 32, the second tank 16 may include a sealing ring 52 which may be configured for creating a fluid tight seal between the second tank 16 and the cover 22 (FIG. 1) when the cover 22 (FIG. 3) is in the closed configuration. In some embodiments, the sealing ring 52 may be secured around an upper most perimeter of the inner cylinder 32. As previously described, the second tank 16 may include the inlet pipe 42 for reception within the second tank 16. As illustrated, the inlet pipe 42 may be coupled with a joint arm 73 which may engage with a bearing 126 when the inlet pipe 42 is coupled with the whirl arm 40, as will be described further herein with reference to FIGS. 8-10.

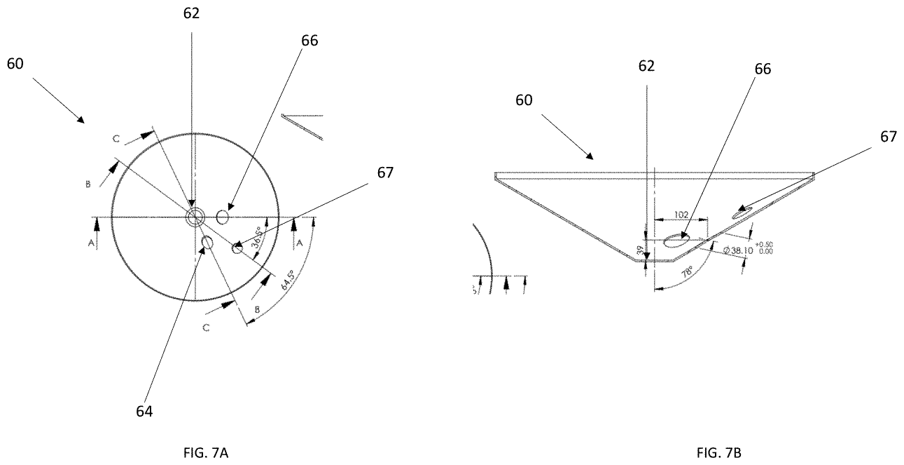

Additionally, with reference still to FIG. 5, the second tank 16 includes a first plate 56 arranged at an upper most extent of the inner cylinder 32. The first plate 56 may be slanted vertically downwards from an outer perimeter to an opening 58 of the first plate 56. This slanted configuration of the first plate 56 may ensure that fluid does not sit on the plate while the second tank 16 is being used, but instead flows into the opening 58 to be received within an interior region of the inner cylinder 32. The first plate 56 may be engaged with the upper perimeter of the inner cylinder 32 through welding, or otherwise adhering, the first plate 56 with the inner cylinder 32. Additionally, the second tank 16 may also include an inner cylinder base 60 which may be configured for engagement with the bottom of the inner cylinder 32. FIGS. 7A-7B illustrate a top view and a cross-sectional view, respectfully, of the inner cylinder base 60. As illustrated in FIGS. 7A-7B, the inner cylinder base 60 includes a first borehole 62 and a second borehole 64 at a central portion of the inner cylinder base 60 to allow for fluid egress through the inner cylinder base 60. The inner cylinder base 60 additionally includes a third borehole 66 and a fourth borehole 67 arranged adjacent the first and second boreholes 62, 64. In this way, the inner cylinder base 60 may work to enclose the inner cylinder 32 while allowing for fluid passage through a specific area of the inner cylinder base 60 to control the fluid passageway.

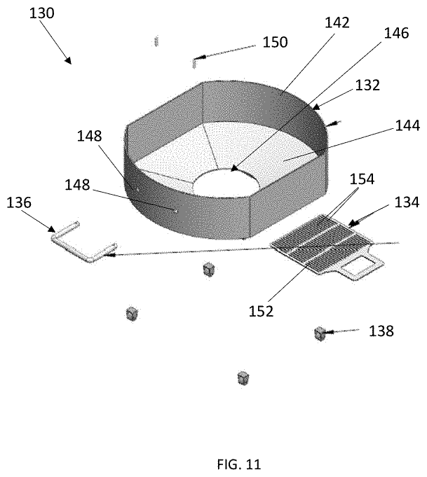

With reference again to FIG. 5, the inner cylinder 32 may include at least one opening 68 extending through the first cylinder wall 36 of the inner cylinder 32. Further, the inner cylinder 32 additionally includes an opening 70 arranged within a center of the inner cylinder 32. As will be described further herein, the opening 70 may align with an opening of the outer cylinder 34 for receiving a grid basket 132 of the second tank 16. More particularly, as illustrated in FIG. 5, the second tank 16 includes a rectangular opening 59 within the center of the outer cylinder 34 which is configured to align with the opening 70 and receiving the grid basket assembly 130 (FIG. 11) within the second tank 16. The grid basket assembly 130 will be described further herein with reference to FIG. 11. Further, the second tank 16 includes a plurality of openings 72 extending through the second cylinder wall 38 of the outer cylinder 34. As will be described further herein, the openings 72 may be configured for receiving various pipes and sensors.

With reference still to FIG. 5, the second tank 16 may receive a liquid level sensor pipe 74, a temperature sensor holder pipe 78, and a water drainpipe 80 within the first cylinder wall 36 of the outer cylinder 34. The temperature sensor holder pipe 78 and the liquid level sensor pipe 74 may work with a temperature sensor and a liquid level sensor, respectively, to monitor the temperature and the liquid level within the second tank 16 during the brewing process of the brewing system 10. Further, the water drainpipe 80 may be used for aiding in the removal of excess vapor and water within the second tank 16. Additionally, with reference still to the exploded view of FIG. 5, an inlet water pipe 82, a yeast pipe fitting 84, and a drain water fitting 86 may also be incorporated for reception within the second tank 16 to work with the various inlet pipes to allow for fluid insertion and removal from the second tank 16. With reference still to FIG. 5, the outer cylinder 34 includes an outer cylinder base 50 configured to engage with a bottom perimeter of the outer cylinder 34. As illustrated, the outer cylinder base 50 includes a first borehole 51 at a central point of the outer cylinder base 50 and a second borehole 53 arranged adjacent the first borehole 51. The boreholes 51, 53 may be configured for receiving various the pipes within the outer cylinder 34. More particularly, the first borehole 51 may receive the outlet pipe 44 while the second borehole 53 may receive the waste-water outlet pipe 46. While illustrated as only comprising two boreholes 51, 53, the outer cylinder base 50 may have any number of openings for receiving various piping.

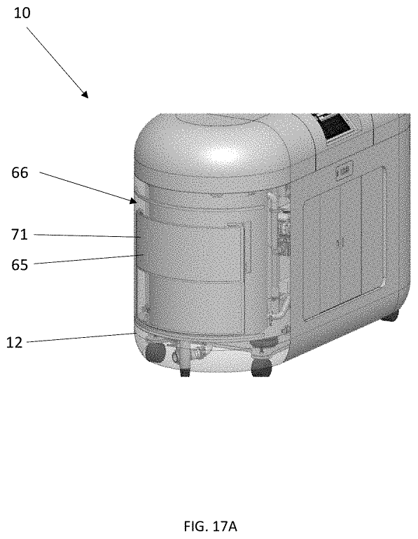

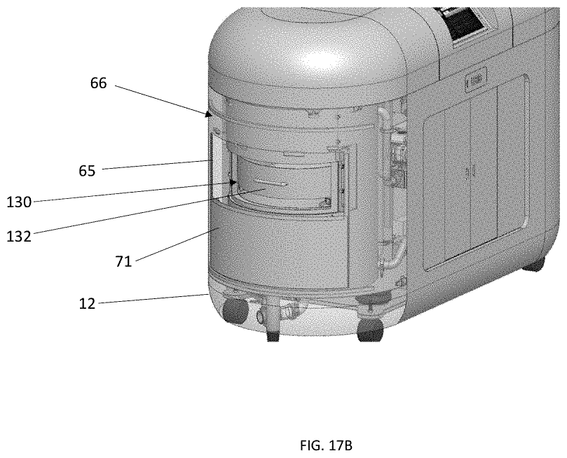

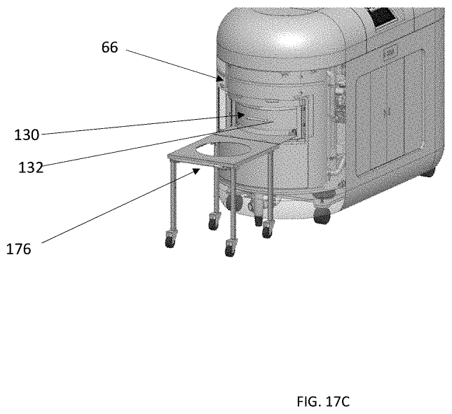

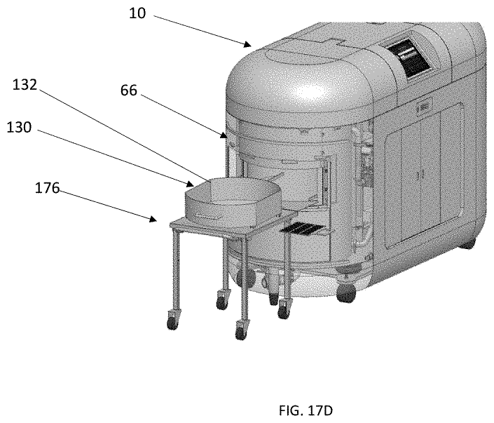

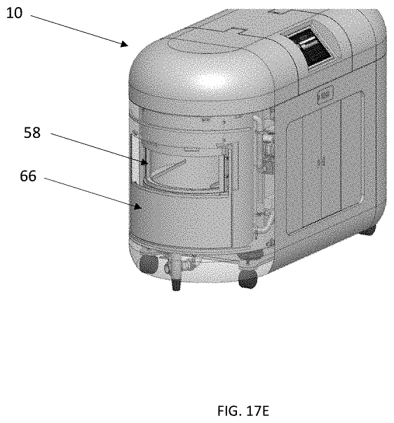

Further, as previously described, the second tank 16 includes a grid basket assembly 130 (FIG. 11) arranged within the second tank 16. As illustrated in FIG. 4, the second tank 16 additionally includes a lauter door assembly 160 that is configured enclosing the grid basket assembly 130 and may actuated by the user for exposing and removing the grid basket assembly 130 during operation. For example, the second tank 16 includes a lauter door reinforcement plate 164 which may engage with bracket support plates 158 through the use of mounting brackets 166 and be received within the opening 59 of the outer cylinder 34. The bracket support plates 158 may support the grid basket assembly 130 and the removal of the grid basket 132, as will be described further with reference to FIGS. 17A-17E.

While examples of brewing system 10 are described as including grid basket assembly 130 and various associated aspects (e.g., openings 68,70, lauter door assembly 160, and bracket support plates 158, etc.), it will be appreciated that, in other examples, such aspects may be omitted. For instance, in such an example, inner cylinder 32 and outer cylinder 34 may each instead have a substantially continuous surface in place of grid basket assembly 130 and the described associated aspects.

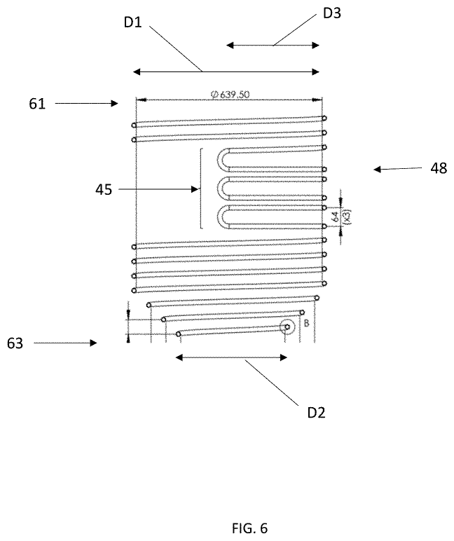

FIG. 6 illustrates an enlarged view of the heating coil 48. As previously described, the coil 48 is arranged between the inner cylinder 32 and the outer cylinder 34. In some embodiments, the coil 48 is a hollow coil 48 configured for receiving a cooling fluid therewithin in order to cool the interior region of the inner cylinder 32, and thus the second tank 16. The coil 48 may be defined by a maximum diameter D1 and a minimum diameter D2. For example, a first, top end 61 may extend at the maximum diameter D1 and the second, bottom end 63 may be defined as the minimum diameter D2. Further, as illustrated, the coil 48 additionally includes a region 45 defined by an intermediate diameter D3 which may have a value that is less than the maximum diameter D1. In further instances, the intermediate diameter D3 may have a value that is greater than the minimum diameter D1. However, such aspects are provided merely as examples and various other values and/or sizing relationships may be incorporated. The region 45 defined by the intermediate diameter D3 forms an opening within a portion of the coil 48 such that the coil 48 does not interfere with the openings 59, 70 of the inner and outer cylinders 32, 34, respectively, and retains the ability for the grid basket assembly 130 to be received therein.

With reference now to FIGS. 8-10, the whirl arm 40 and the inlet pipe 42 will be described further herein. For example, FIG. 8 illustrates an enlarged side perspective view of the inlet pipe 42. As illustrated, the inlet pipe 42 has a first end 41 and a second end 43. The first end 41 may be configured for engagement with the whirl arm 40, as will be described further herein with reference to FIGS. 8-10. Adjacent the first end 41, the inlet pipe 42 includes a first curved portion 47 which is coupled with a first connector piece 49. Further, the inlet pipe 42 includes an angled portion 57 which may be coupled with a second connector piece 54 such that the angled portion 57 is arranged between the first connector piece 49 and the second connector piece 54. The second end 43 is coupled with the second connector piece 54 through a second curved portion 55. As illustrated, the angled portion 57 extends at an angle of approximately 35 degrees relative to a horizontal axis Y. However, in other embodiments, the angled portion 57 may extend at an angle that is less then or greater than approximately 35 degrees.

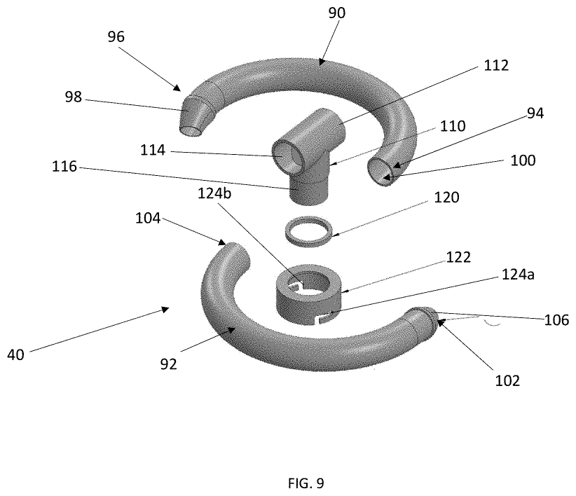

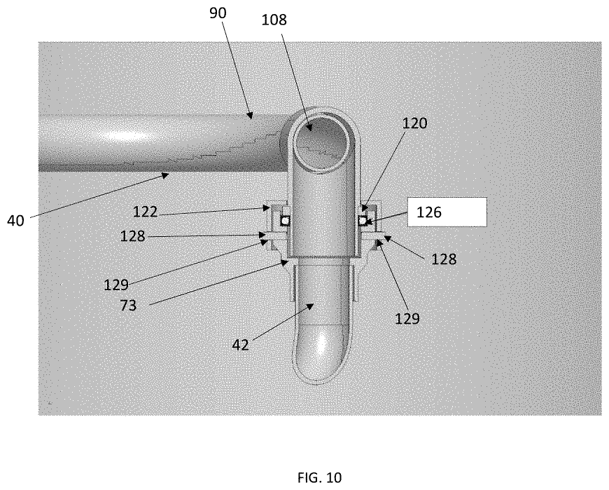

With reference now to FIGS. 9-10, the whirl arm 40 of the brewing system 10 will be described further herein. As illustrated best in the exploded view of FIG. 9, the whirl arm 40 includes a first curved pipe 90 and a second curved pipe 92. The first curved pipe 90 includes a first end 94 and a second end 96, the first end 94 having a narrowed portion 98. Further, as illustrated, the first curved pipe 90 is hollow such that a lumen 100 is defined as extending therethrough. With reference still to FIG. 9, the second curved pipe 92 also comprises a first end 102 and a second end 104 opposite the first end 102. As illustrated, the first end 102 comprises a narrowed portion 106. Further, the second curved pipe 92 is hollow such that a lumen (not shown) is extending therethrough. In this way, both the first curved pipe 90 and the second curved pipe 92 are capable of receiving fluid such that the fluid may enter and exit the whirl arm 40 through the first and second curved pipes 90, 92. More particularly, and as will be described further herein, the whirl arm 40 may be fluidly coupled with the inlet pipe 42 for receiving a fluid to cause rotation of the whirl arm 40 during operation.

As illustrated in FIGS. 9 and 10, the whirl arm 40 is coupled to the inlet pipe 42 through a pipe coupler, illustratively a T-pipe coupler 110. The T-pipe coupler 110 includes a first pipe 112 having a first end 113 and a second end 114, and a bottom pipe 116 extending vertically downward from the first pipe 112. As illustrated, the second end 96 of the first curved pipe 90 may be received within the first end 113 of the first pipe 112 while the second end 104 of the second curved pipe 92 may be received within the second end 114 of the first pipe 112. The inlet pipe 42 may be received within the bottom pipe 116 of the T-pipe coupler 110. Further, the T-pipe coupler 110 may engage with a cover 122. In some embodiments, the cover 122 may be received over a portion of the bottom pipe 116 of the T-pipe coupler 110 prior to engagement with the inlet pipe 42. As illustrated, the cover 122 includes a first slot 124a and a second slot 124b which may facilitate allowing engagement between the cover 122 and the T-pipe coupler 110.

FIG. 10 illustrates a cross sectional view of the coupling between the inlet pipe 42 and the whirl arm 40 facilitated by the cover 122 and the T-pipe coupler 110. The whirl arm 40 is illustrates as extending within the T-pipe coupler 110. As illustrated, the cover 122 may be arranged around the bottom pipe 116 and the stopper ring 120 may be disposed around the bottom pipe 116 vertically below the cover 122 and in abutment with the cover 122. Further, as illustrated in FIG. 10, the T-pipe coupler 110 comprises a plurality of protrusions 128 which may engage with openings 129 of the joint arm 73 to couple the inlet pipe 42 and the joint arm 73. Further, the protrusions 128 may extend into the slots 124a, 124b of the cover 122 such that when the cover 122 is rotated into a locked position, the cover 122 and the T-pipe coupler 110 are fixed with one another. Additionally, a bearing 126 may be arranged below and in abutment with the stopper ring 120. In some examples, the bearing 126 is a Teflon bearing. The bearing 126 may function to reduce friction between the stopper ring 120, the joint arm 73, and the T-pipe coupler 110 during rotation of the whirl arm 40, and thus rotation of the T-pipe coupler 110. For example, inlet pipe 40 is fixed within the T-pipe coupler 110 with one or more T-clamps.

The above recited fluid coupling between the T-pipe coupler 110 and the whirl arm 40 allows for fluid to enter into the whirl arm 40 to cause rotation of the whirl arm 40, causing an implosive and/or vortex effect within the first tank 14 during the fluid flow through the whirl arm 40. Depending on the phase of the brewing process, the rotation of the whirl arm 40 may have varying speeds, for example varying rotations per minute (rpm). More particularly, needle bearings (not shown) may allow for hydrodynamics to control the rotational speed of the whirl arm 40. The function of the lauter tank 16 and its various components during steps of the brewing process will be described further herein.

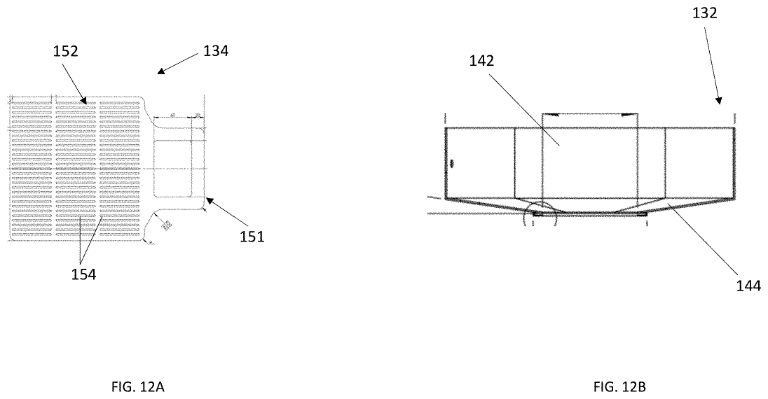

With reference now to FIG. 11, the grid basket assembly 130 will be described. As illustrated, the grid basket assembly 130 includes a grid basket 132, a mesh plate 134, a handle 136, and a plurality of basket wheels 138. As illustrated, the grid basket 132 has a generally cylindrical shape defined by an outer wall 142 extending around an entirety of the grid basket 132. The grid basket 132 further includes a bottom plate 144 that extends radially inward from the outer wall 142 and is slanted at least partially vertically downwards to create a slant in the bottom plate 144, also shown in FIG. 12B, which is an enlarged view of the grid basket 132. The bottom plate 144 is also defined by a central opening 146 which may allow for the passage of fluids through the grid basket 132 as will be described further herein. Additionally, the outer wall 142 of the grid basket 132 comprises at least two openings 148 for receiving the handle 136 of the outer wall 142. The handle pins 150 may be used for securing the handle 136 position within the openings 148 of the outer wall 142 of the grid basket 132. The handle 136 may be used for actuating the grid basket 132 during operation, as will be described further. Additionally, the plurality of basket wheels 138 are coupled with a bottom portion of the grid basket 132 to allow for the grid basket 132 to be rolled in and out of the second tank 16 upon actuation of the handle 136.

Further, as illustrated in the enlarged view of FIG. 12A, a majority of the mesh plate 134 is illustrated comprising a mesh surface 152 having a plurality of apertures 154 that allow for fluid passage through the mesh plate 134. In operation, and as will be described further herein, the portion of the mesh plate 134 having the mesh surface 152 will be arranged below the central opening 146 of the grid basket 132.

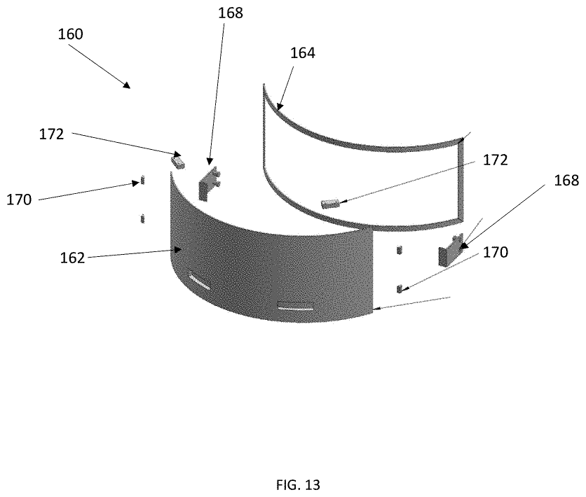

With reference now to FIG. 13, the lauter door assembly 160 for the grid basket assembly 130 will be described herein. The lauter door assembly 160 may be configured for engagement with the second tank 16 to allow for the removal and actuation of the grid basket assembly 130. As illustrated, the lauter door assembly 160 may include a lauter door 162, the lauter door reinforcement plate 164 coupled with the lauter door 162, at least one bracket 168, at least one hook snapper plate 170, and at least one ball catch mounting plate 172. As illustrated, the lauter door 162 has a generally rectangular and curved profile. The lauter door reinforcement plate 164 has a generally rectangular profile with an opening extending therethrough, and the lauter door reinforcement plate 164 may couple with an inner surface of the lauter door 162.

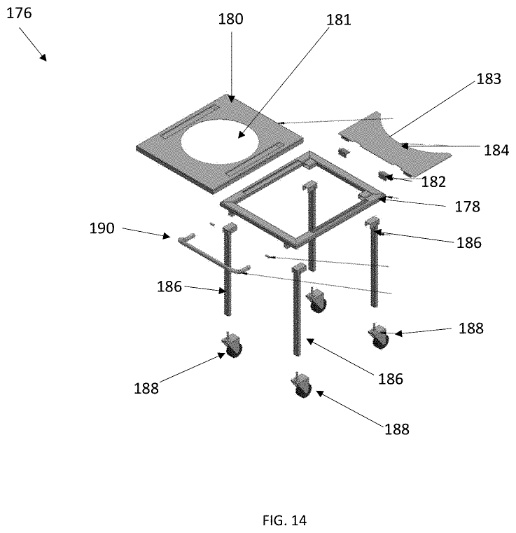

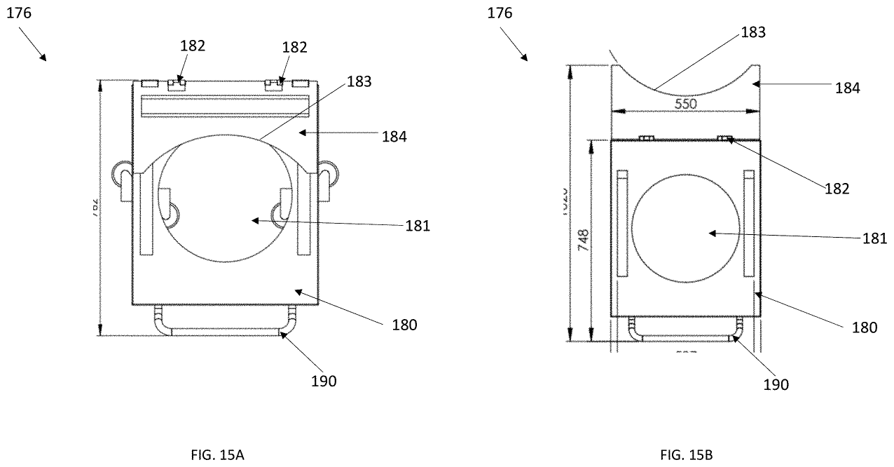

Further, with reference now to FIG. 14, the brewing system 10 may include a trolley assembly 176 which may be configured for supporting and carrying the grid basket assembly 130 upon removal from the second tank 16, as will be described further with reference to FIGS. 17A-17E. As illustrated in the exploded view of FIG. 14, the trolley assembly 176 includes a trolley plate 178 configured for receiving a trolley plate cover 180. The trolley assembly 176 includes a plurality of hinges 182 for coupling a folding plate 184 with the trolley plate 178 and the trolley plate cover 180. For example, FIGS. 15A-15B illustrated a top schematic view of the trolley plate cover 180 coupled with the folding plate 184, and more particularly, the folding plate 184 in a folded configuration (FIG. 15A) and an extended configuration (FIG. 15B). More specifically, in the configuration of FIG. 15B, the folding plate 184 has been hinged outward relative to the trolley plate cover 180 into the extended position. As will be described further with reference to FIGS. 17A-17E, arranging the folding plate 184 into the extended configuration may aid in the retraction of the grid basket assembly 130 during operation of the brewing system 10.

With reference again to FIG. 14, the trolley assembly 176 additionally includes a plurality of trolley legs 186 which are received within a bottom surface of the trolley plate 178 for supporting the trolley assembly 176. As illustrated, a plurality of wheels 188 may be received within bottom portions of the plurality of trolley legs 186. In this way, when the components are coupled with one another, the trolley assembly 176 may be transported easily on the plurality of wheels 188. Additionally, the trolley assembly 176 includes a trolley handle 190 coupled with the trolley plate 178 which may be actuated by an operator to move the trolley assembly 176.

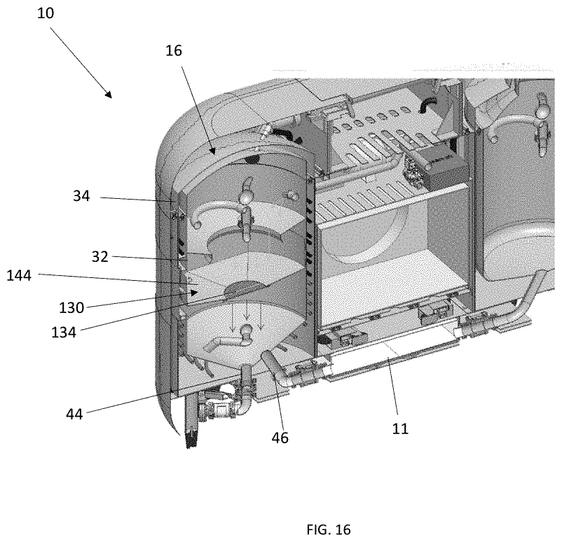

Once the above-described components are assembled within the outer housing and within the second tank 16, fluid, such as mash, is able to flow through the second tank 16 and thus through the grid basket assembly 130. This process will be described further with reference to the cross-sectional view of FIG. 16.

As illustrated in FIG. 16 and indicated by the arrows, mash is able to flow from the inlet pipe 42 into the second tank 16, and more particularly, into the interior region of the inner cylinder 32 of the second tank 16. The mash may then flow vertically downwards within the inner cylinder 32 and through to the grid basket assembly 130. More particularly, the mash may flow into the grid basket 132 and through the mesh plate 134 positioned below the central opening 146 of the grid basket assembly 130. While the mash flows through the mesh plate 134, particles have a size that is greater than a size of the plurality of apertures 154 of the mesh surface 152 are caught by the mesh plate 134 and are unable to pass through the mesh plate 134 of the grid basket assembly 130. The materials that are gathered within the grid basket assembly 130 and do not pass through the mesh plate 134 may be referred to as the mash cake.

Further, the particles of the mash that have a size that is less than a size of the plurality of apertures 154 may pass through the mesh surface 152 and flow into a lower portion of the inner cylinder 32 of the second tank 16. The particles that may flow through mesh plate 134 and into the lower portion of the second tank 16 may be referred to as the “wort.” The wort may then pass through the outlet pipe 44 of the second tank 16. The fluid coupling system 30, in combination with the inlet pipe 42 of the second tank 16, causes continuous transfer of the wort through the second tank 16 such that the wort is repeatedly transferred into the upper portion of the second tank 16 and pushed through the grid basket assembly 130. The wort may be repeatedly processed through the grid basket assembly 130 so that all of the required mash cake may be gathered by the grid basket 132 to completely clarify the wort. This may be repeated until the wort is clarified to a desired amount, which may be measurable by evaluating the clarity of the wort. For example, in some instances, the second tank 16 may include a turbidity sensor for evaluating the color and clarity of the wort. In other instances, the second tank 16 may include a glass window, camera and/or flow sensor for evaluating the clarity of the wort. However, various other methods for evaluating the clarity of the wort. Once the wort is clarified to an acceptable amount, the wort may exit the second tank 16 through the fluid coupling system 30 and enter the first tank 14 for further processing. Once the wort no longer needs to be circulated through the second tank 16, the grid basket assembly 130 may be removed so that the mash cake can be disposed of.

For example, with reference to FIGS. 17A-17E, the removal of the grid basket assembly 130 and disposal of the mash cake from the grid basket assembly 130 will be described further herein. FIG. 17A illustrates a side perspective view of the outer housing 12 of the brewing system 10, and more particularly a portion of the outer housing 12 having the second tank 16. As illustrated, the outer housing 12 includes a second tank cover plate 66 which may engage with the remaining of the outer housing 12 and at least partially enclose the second tank 16. The second tank cover plate 66 includes a window panel 65 which may slide upwards and downwards to reversibly cover the grid basket assembly 130 within the second tank 16. For example, FIG. 17A illustrates the lauter door 162 in a closed configuration that encloses the grid basket assembly 130 such that the grid basket 132 is not visible to the user. In the perspective view of FIG. 17B, the window panel 65 of the second tank cover plate 66 has been actuated downwards along with the lauter door assembly 160 such that the grid basket assembly 130 is exposed to the user. Once the grid basket assembly 130 is revealed to the user, the handle 136 may be actuated by the user (i.e., pulled) to remove the grid basket assembly 130 from the second tank 16 and towards a user that is exterior to the outer housing 12. In some instances, the trolley assembly 176 may be arranged adjacent the outer housing 12 to support the grid basket assembly 130 once removed from the second tank 16 of the outer housing 12.

For example, FIG. 17C illustrates the brewing system 10 with the grid basket assembly 130 exposed to the user and the trolley assembly 176 position directly adjacent the outer housing 12 of the second tank 16. As illustrated, the folding plate 184 is flipped outward towards the grid basket assembly 130, and the trolley plate 178 is positioned at a vertical height that is directly below a vertical height of a bottom surface of the grid basket assembly 130. In this way, the user may pull the handle 136 to remove the grid basket assembly 130 from within the second tank 16 and place it directly onto the trolley assembly 176. For example, FIG. 17D illustrates the grid basket 132 supported by the trolley assembly 176, and more particularly placed onto the trolley plate 178. Once the grid basket 132 is placed onto the trolley plate 178, the user may easily transport or roll the trolley assembly 176 so that the grid basket assembly 130 can be disposed of outside of the brewing system 10. For example, the user may dump the mash cake caught in the grid basket assembly 130 into a waste disposal that is separate from or external relative to the brewing system 10. FIG. 17E illustrates the brewing system 10 after removal of the grid basket assembly 130 and after the trolley assembly 176 has been moved. As illustrated, the mounting brackets 166 remain within the second tank 16 and may be configured for receiving the grid basket assembly 130 once the user is ready to insert the grid basket assembly 130 back into the second tank 16.

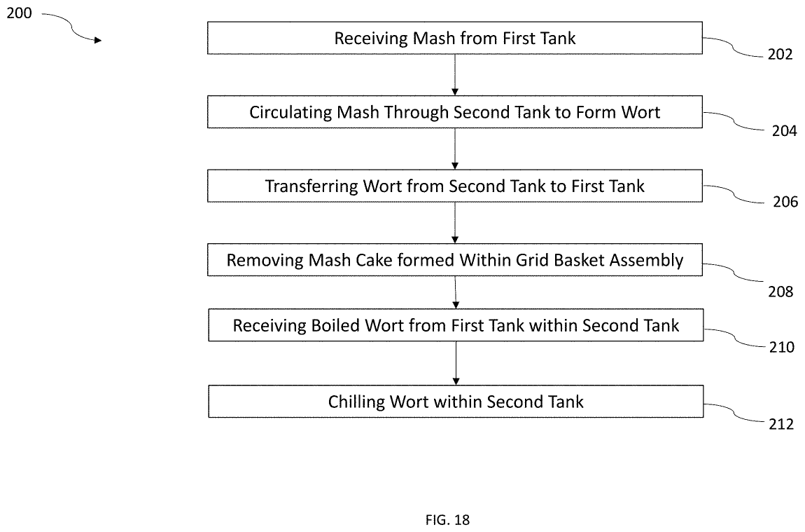

With reference now to the flow chart of FIG. 18, a method 200 for using the second tank 16 during the process of brewing a liquid, for example beer, will be described. As illustrated, at block 202 the method 200 first includes receiving mash from the first tank 14 into the second tank 16. This may be conducted through the fluid coupling system 30 and facilitates the transfer of the mash into the second tank 16 through the inlet pipe 42. At this step, the mash may have already been processed and formed through the mashing of grains within the first tank 14. Once the mash is received within the second tank 16, the method 200 then includes the step illustrated at block 204 which includes circulating the mash through the second tank 16 to form a wort. In some embodiments, the step at block 204 forms additional particles outside of the wort. More particularly, the process conducted with reference to FIGS. 16-17E is conducted. This process of filtering the mash to form the wort may be repeated until the wort meets a predetermined clarity standard. As previously described, various factors such as a visual test of clarity, the pH and other features may be examined to determined when the wort is clear.

The method 200 then includes the step at block 206 of transferring the wort from the second tank 16 into the first tank 14 for further processing. This may be conducted through actuation of the fluid coupling system 30 in combination with the outlet pipe 44 of the second tank 16. Further, this process of the removal may be automatically conducted by the brewing system 10 once it is determined that the wort is clarified. The method 200 then includes the step at block 208 of removing the grid basket assembly 130 from the second tank 16 in order to empty the grid basket 132 of the mash cake that has been gathered.

The method 200 may then include the step at block 210 of receiving boiled wort from the first tank 14 into the second tank 16. This step may be automatically conducted by the brewing system 10 through actuation of the fluid coupling system 30. However, during this step, rather than transferring the boiled wort through the inlet pipe 42, this may be done through the outlet pipe 44. In this way, the boiled wort enters the second tank 16 through the bottom of the second tank 16 and fills the second tank 16. This may reduce the amount of carbon dioxide and oxygen build up within the second tank 16. In some embodiments, prior to the step at block 210, the second tank 16 is pre-chilled. This may be done through the use of the glycol chiller arranged within the fluid coupling system 30 which allows 116 liters of water to run between the inner cylinder 32 and the outer cylinder 34 through the coil 48 arranged between the inner cylinder 32 and the outer cylinder 34 of the second tank 16. The water may be at a temperature of approximately 7 degrees Celsius to aid in the cooling of the second tank 16 to the desired temperature. In some instances, the second tank 16 may be chilled as low was four degrees Celsius.

Once the wort has been transferred into the second tank 16, the method 200 further includes the step at block 210 of chilling the wort. In some instances, the wort may remain in the second tank 16 while being chilled for between approximately one hour and approximately two hours. In some instances, the wort is chilled within the second tank 16 for an hour and a half. In some embodiments, after the wort is properly chilled, the brewing system 10 may receive an indication to transfer the wort to a separate tank for fermentation. This may be completed through the fluid coupling system 30.

The above-described brew component, i.e., the first tank 14, cooperates with the remaining components of the brewing system 10 in order to create a brewing system 10 having several advantages and benefits over the standard equipment that is currently used for brewing beer. The first tank 14 described herein allows for the mashing of the malt to be conducted within one tank and easily transferred to the second tank 16 through the fluid coupling system 30. While described herein with reference only to the mashing of malt for the production of beer, the first tank 14 may be purposed for brewing of another liquid and/or another process such as distillation of a liquid.

The following clauses are provided as example aspects of the disclosed subject matter:
1. A component of a brewing system having an outer housing enclosing at least the component and a fluid coupling system, the component comprising: a tank including an inner cylinder disposed at least partially within an outer cylinder; a whirl arm disposed within an upper portion of the tank; an inlet pipe fluidly coupled with the whirl arm; and an outlet pipe fluidly coupled with the fluid coupling system of the brew system; wherein the tank component is configured for filtering a mash to form a wort.
2. The component of clause 1, wherein the first tank is fluidly coupled to a second tank within the outer housing through the fluid coupling system.
3. The brewing system of clause 1, wherein the first tank has a volumetric capacity of approximately 240 liters.
4. The brewing system of clause 1, wherein the inner cylinder and the outer cylinder are composed of stainless steel.
5. The brewing system of clause 1, wherein the brewing system includes a second cover reversibly coupled with the second tank through a hinge assembly.
6. The component of clause 1, wherein the whirl arm is composed a first portion and a second portion and wherein each of the first portion and the second portion define a lumen extending therethrough.
7. The brewing system of clause 6, wherein the inlet pipe is coupled with the whirl arm through a T-pipe coupler such that the inlet pipe is configured for delivering a fluid into the lumen of the first portion and the second portion of the whirl arm.
8. The brewing system of clause 7, wherein the T-pipe coupler comprises a first pipe adjacent a second pipe and a bottom pipe extending vertically below the first pipe and the second pipe, and wherein a stopper ring and a bearing are disposed around the bottom pipe.
9. The component of clause 1, wherein the outer tank comprises a first opening for receiving the outlet pipe to fluidly couple the first tank and the fluid coupling system within a bottom portion of the first tank.
10. The component of clause 9, wherein the outer tank comprises a second opening for receiving a waste-water outlet pipe for fluidly coupling the first tank with a waste-water tank of the brewing system.
11. The component of clause 1, wherein the first tank comprises a temperature sensor pipe received at least partially therewithin for operation with a temperature sensor to monitor the temperature within the first tank.
12. The component of clause 1, wherein the first tank comprises a liquid level sensor pipe received at least partially within the first tank for operation with a liquid level sensor to monitor the liquid level within the first tank.
13. The component of clause 1, wherein the first tank includes a pressure outlet pipe received at least partially within the first tank for operation with a pressure sensor to monitor the pressure within the first tank.
14. A brewing system, comprising: a first tank arranged adjacent to a second tank and a fluid coupling system arranged between the first tank and the second tank, the second tank comprising: an inner cylinder disposed at least partially within an outer cylinder; a whirl arm arranged within an upper portion of the second tank; an inlet pipe fluidly coupled with the whirl arm and the fluid coupling system; and an outlet pipe fluidly coupled with the fluid coupling system; wherein the first tank has a volumetric capacity of approximately 240 liters.
15. The brewing system of clause 14, wherein whirl arm is comprised of a first portion and a second portion and wherein each of the first portion and the second portion comprises a lumen extending therethrough.
16. The brewing system of clause 1, wherein the second tank comprises a second tank cover having an opening for receiving a waste-water outlet pipe for fluidly coupling the second tank with a waste-water tank of the brewing system.
17. A method of brewing a beverage using a brewing system, wherein the brewing system includes a first tank positioned adjacent to and fluidly coupled with a second tank, the method including: receiving mash within the second tank from the first tank; circulating mash through the second tank to form wort; transferring the wort from the second tank into the first tank; removing mash cake formed within a grid basket assembly of the second tank; receiving boiled wort within the second tank from the first tank; and chilling the wort within the second tank.
18. The method of clause 17, further comprising: performing the circulating step automatically.
19. The method of clause 18, further comprising: cleaning the second tank after transferring the wort from the second tank to the first tank.
20. The method of clause 18, wherein prior to receiving boiled wort from the first tank within the second tank, the method includes pre-chilling the second tank through circulating chilled fluid through coils between an inner cylinder and an outer tank of the second cylinder.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided the description and illustration of the present application, one skilled in art may envision variations, modifications, and alternate aspects falling within the spirit of the broader aspects of the general inventive concept embodied in this application that do not depart from the broader scope of the claimed disclosure.

1. A component of a brewing system having an outer housing enclosing at least the component and a fluid coupling system, the component comprising:
a tank including an inner cylinder disposed at least partially within an outer cylinder;
a whirl arm disposed within an upper portion of the tank;
an inlet pipe fluidly coupled with the whirl arm; and
an outlet pipe fluidly coupled with the fluid coupling system of the brew system;
wherein the tank component is configured for filtering a mash to form a wort.

2. The component of claim 1, wherein the first tank is fluidly coupled to a second tank within the outer housing through the fluid coupling system.

3. The brewing system of claim 1, wherein the first tank has a volumetric capacity of approximately 240 liters.

4. The brewing system of claim 1, wherein the inner cylinder and the outer cylinder are composed of stainless steel.

5. The brewing system of claim 1, wherein the brewing system includes a second cover reversibly coupled with the second tank through a hinge assembly.

6. The component of claim 1, wherein the whirl arm is composed a first portion and a second portion and wherein each of the first portion and the second portion define a lumen extending therethrough.

7. The brewing system of claim 6, wherein the inlet pipe is coupled with the whirl arm through a T-pipe coupler such that the inlet pipe is configured for delivering a fluid into the lumen of the first portion and the second portion of the whirl arm.

8. The brewing system of claim 7, wherein the T-pipe coupler comprises a first pipe adjacent a second pipe and a bottom pipe extending vertically below the first pipe and the second pipe, and wherein a stopper ring and a bearing are disposed around the bottom pipe.

9. The component of claim 1, wherein the outer tank comprises a first opening for receiving the outlet pipe to fluidly couple the first tank and the fluid coupling system within a bottom portion of the first tank.

10. The component of claim 9, wherein the outer tank comprises a second opening for receiving a waste-water outlet pipe for fluidly coupling the first tank with a waste-water tank of the brewing system.

11. The component of claim 1, wherein the first tank comprises a temperature sensor pipe received at least partially therewithin for operation with a temperature sensor to monitor the temperature within the first tank.

12. The component of claim 1, wherein the first tank comprises a liquid level sensor pipe received at least partially within the first tank for operation with a liquid level sensor to monitor the liquid level within the first tank.

13. The component of claim 1, wherein the first tank includes a pressure outlet pipe received at least partially within the first tank for operation with a pressure sensor to monitor the pressure within the first tank.

14. A brewing system, comprising:
a first tank arranged adjacent to a second tank and a fluid coupling system arranged between the first tank and the second tank, the second tank comprising:
an inner cylinder disposed at least partially within an outer cylinder;
a whirl arm arranged within an upper portion of the second tank;
an inlet pipe fluidly coupled with the whirl arm and the fluid coupling system; and
an outlet pipe fluidly coupled with the fluid coupling system;
wherein the first tank has a volumetric capacity of approximately 240 liters.

15. The brewing system of claim 14, wherein whirl arm is comprised of a first portion and a second portion and wherein each of the first portion and the second portion comprises a lumen extending therethrough.

16. The brewing system of claim 1, wherein the second tank comprises a second tank cover having an opening for receiving a waste-water outlet pipe for fluidly coupling the second tank with a waste-water tank of the brewing system.

17. A method of brewing a beverage using a brewing system, wherein the brewing system includes a first tank positioned adjacent to and fluidly coupled with a second tank, the method including:
receiving mash within the second tank from the first tank;
circulating mash through the second tank to form wort;
transferring the wort from the second tank into the first tank;
removing mash cake formed within a grid basket assembly of the second tank;
receiving boiled wort within the second tank from the first tank; and
chilling the wort within the second tank.

18. The method of claim 17, further comprising:
performing the circulating step automatically.

19. The method of claim 18, further comprising:
cleaning the second tank after transferring the wort from the second tank to the first tank.

20. The method of claim 18, wherein prior to receiving boiled wort from the first tank within the second tank, the method includes pre-chilling the second tank through circulating chilled fluid through coils between an inner cylinder and an outer tank of the second cylinder.
